(19) United States
(12) Patent Application Publication
(10) Pub. No.: US 2015/0016144 A1
(43) Pub. Date: Jan. 15, 2015

(54) Functional Support with Button Functions

(71) Applicant: Abatek International AG, Bassersdorf (CH)

(72) Inventors: Christoph Keist, Wattwil (CH); Frank Ehrig, Jona (CH); Swen Keiser, Dottikon (CH); Daniel Marty, Wetzikon (CH)

(73) Assignee: Abatek International AG, Bassersdorf (CH)

(21) Appl. No.: 14/276,386

(22) Filed: May 13, 2014

(30) Foreign Application Priority Data
May 13, 2013 (CH) 00942/13

(51) Int. Cl. B29C 45/14; F21V 8/00

(52) U.S. Cl. CPC B29C 45/14024; B29C 45/14008; G02B 6/0081
USPC 362/611; 264/163; 264/279

(57) ABSTRACT

A process for producing a multifunctional functional support in which operating elements or display elements are arranged. The process includes flexible transparent plastic film supplied from a roll; the flat plastic film is placed into an injection mold, and is backmolded to form a rigid support structure-on a first side, wherein in the region of the operating elements or display elements it remains exposed in the form of at least two clearances; on the second side the plastic film is flooded in the same injection mold with a transparent curing casting compound in an RIM process to form a transparent surface layer, membrane regions that are flexible at least in places being formed in the region of the clearances; operating elements or display elements are placed into the clearances and joined to the plastic support.

### CROSS-REFERENCE TO RELATED APPLICATION

This application claims priority to Switzerland Patent Application No. 00942/13 filed May 13, 2013, the disclosure of which is hereby incorporated in its entirety by reference.

### BACKGROUND OF THE INVENTION

1. Field of the Invention

The present invention relates to a process for producing a multifunctional functional support, for example a console structure for a vehicle or a device, with a rigid support structure, in which operating elements and/or display elements are arranged behind a transparent surface layer which is continuous over substantially the entire functional support. The invention also relates to functional supports produced in this way.

2. Description of Related Art

Today, operating elements and display devices as well as buttons of all types are incorporated in automobile interiors in clearances in a large panel. This results in gaps and material transitions.

The solutions known today can be summarized as follows:

Membrane keypads with embossings or coating application: Membrane keypads meet the requirements of a continuous surface and, through embossings or selective coating or silicone application, formed-on button geometries, but are always restricted to a flat basic geometry. See for example DE 20 2005 012 021 U1.

Thermoformed film: Thermoforming allows films to be brought into a three-dimensional form and also allows button geometries to be formed on. Limitations are set by the necessary bending radii (no sharp edges are possible), the minimum distance between buttons (there must be sufficient material between the buttons for the thermoforming). The functional actuation of such a button is also not simple to achieve, since the deformed film also has to follow the travel of the button when it is depressed. Such films also have a strong tendency to fail quickly in an actuation endurance test.

Silicone surface: Freely formed functional operator interfaces can be produced from silicone. This solution is distinguished by a soft surface and limited brilliance of the silicone colours. For this reason, this solution is often not chosen specifically for large-area applications.

### SUMMARY OF THE INVENTION

One of the aims of this invention is to produce a continuous three-dimensionally formed panel with integrated operating and/or display elements from a plastic with a high-quality appearance. In this respect, the operating elements/buttons preferably have tactile feedback, which is of key importance for operating reliability.

Consequently, the present invention relates firstly to a process and also to a correspondingly produced multifunctional functional support.

Specifically, the invention relates on the one hand to a process for producing a multifunctional functional support with a rigid support structure, in which operating elements and/or display elements are arranged behind a transparent surface layer which is continuous over substantially the entire functional support. The process is in this case characterized in particular in that at least the following steps are performed:
i) a flat, flexible plastic film which is preferably transparent at least in places and has a thickness in the range of 0.05-0.4 or 0.1-0.4 mm is introduced, in that it is supplied from a roll, and a means for positioning in an injection mould, for example in the form of a positioning mark, is preferably applied to this film;
ii) the flat plastic film is placed in a precisely positioned manner, for example using the at least one positioning mark (a multiplicity of such marks is also possible), into an injection mould and the plastic film is backmoulded to form a substantially continuous hard plastic support on the first side, the injection mould being designed in such a way that, in the region of the operating elements and/or display elements, the plastic film is not backmoulded, at least in places, and remains exposed in the form of at least one or two clearances;
iii) on the second side, facing away from the first side, the plastic film is flooded in the same injection mould or, after transferring the blank into a further injection mould, in this further injection mould, substantially all over with a transparent curing (self-curing, curing in the presence of a separate curing agent, and/or thermosetting) casting compound in an RIM process (reaction injection moulding), and is coated to form a continuous transparent surface layer with a thickness of at least 0.1 mm over substantially the entire functional support, membrane regions that are flexible at least in places being formed in the region of the clearances (in this respect it is also possible for the mould to be closed somewhat further after injection of the casting compound, so that a very thin layer of casting compound is possible);
iv) operating elements and/or display elements are placed into the clearances and joined to the plastic support.

A first preferred embodiment of this process is characterized in that, before, during or after step i), the plastic film is printed and/or decorated preferably on the first and/or the second side, preferably in a screen printing process, a laser printing process, a stamp printing process, a spray printing process, an offset printing process or a digital printing process. —When the roll is being drawn through the injection mould, it is positioned by printed-on positioning marks. On the (TPU) roll there is for example for each image a positioning mark printed on respectively to the left and right in a black colour. To the left for the longitudinal alignment for example a square box, to the right for the lateral alignment an oblong bar. These positioning marks are detected by a respective optical sensor in the injection mould and then the roll is automatically positioned correctly for each individual image by means of advancement and lateral correction. These marks may be applied in this printing step. The positioning may be additionally performed with previously punched positioning holes.

Alternatively or in addition, it is possible according to a further preferred embodiment to print the blank at least in places after step ii), preferably using one of the aforementioned processes, and/or to decorate it. Alternatively, it is possible to subject the blank to laser marking. The marking is particularly advantageous in this phase of the production process if it cannot be ensured in the course of the backmoulding that the position of the film is arranged exactly precisely over the future positions of the switching elements/display elements.

A further preferred embodiment is characterized in that, by step ii), the plastic film is transformed at least in places into a three-dimensional surface form and stabilized in it. In other words, in the course of step ii), the film may either remain in its flat position, or else it may be brought into a three-dimensional surface form, either by being placed into the injection mould in a correspondingly formed way or by the actual process of the backmoulding.

The operating element is preferably at least one switch with tactile feedback.

A further preferred embodiment is characterized in that the display element is an LCD display, preferably a (resistive or capacitive) touch-sensitive display.

A further preferred embodiment is characterized in that the functional support has both at least one operating element in the form of a switch with tactile feedback and at least one display element, preferably a resistive or capacitive touch-sensitive display element.

A further preferred embodiment is characterized in that the plastic film is a plastic film of TPE, TPU (thermoplastic polyurethane elastomers) or of polyamide, preferably of polyamide 6 or polyamide 12, or of TPU. A preferred embodiment is generally characterized in that the plastic film has a thickness in the range of 150-300 μm, preferably in the range of 150-225 μm.

A further preferred embodiment is characterized in that the casting compound for forming the surface layer is a transparent polyurethane resin that cures in the presence of a curing agent, is self-curing and/or thermosetting, said resin having at least in the region of the operating elements and the membrane regions arranged at least partially around them a thickness of no more than 0.4 mm, and the surface layer preferably having in these regions a thickness of at least 0.2 mm.

According to a preferred embodiment, it generally proves to be advantageous if the production process that is used is characterized in that the plastic film is supplied from a roll, preferably in a form in which it is already printed on the front side and/or the rear side, is also removed again to a roll (apart from the cut-out regions) and, in a first processing step, is backmoulded in a first injection mould to form the hard plastic support. Preferably, before the closing of the mould, the plastic film is stretched over convex regions of the mould, covering them, and/or brought to bear against concave regions of the mould by using negative pressure (in that corresponding vacuum channels are provided in the mould), and is subsequently clamped in the edge region, preferably around the periphery, and then the mould is closed.

It may in this respect be advantageous if, when closing and/or opening the mould, the plastic film is automatically cut right away to a peripheral contour.

After the first processing step, the resultant blank may be flooded on the side of the plastic film that is opposite from the hard plastic support with the transparent curing casting compound, the blank preferably being removed from the first injection mould, preferably with the aid of an ejector, and placed into a second mould, and the curing casting compound being moulded on in this mould to form the transparent surface layer. In this respect, the blank is preferably subsequently cut to the peripheral final component contour to form the component.

The component may subsequently be completed by adding further functional elements, in particular snap domes, printed circuit boards or lighting elements.

The present invention also relates to a multifunctional functional support with at least one operating element and preferably at least one display element, characterized by a plastic film of a thickness in the range of 0.05-0.4 or 0.1-0.4 mm, directly backmoulded on a first side with a hard plastic support which is continuous apart from at least one or two clearances, which film has on the opposite, second side a direct, substantially continuous transparent surface layer of a cured casting compound. In this case there is arranged in at least one of the clearances at least one operating element in the form of a switch, preferably with tactile feedback, around which there is a flexible membrane region, around at least part of the periphery, to allow the travel of the button, in which region the flexible layered structure consists only of the optionally printed plastic film and the surface layer.

A first preferred embodiment of such a functional support is characterized in that it is produced in a process such as that described above.

A further preferred embodiment of the functional support is characterized in that it also has at least one display element, and in that the at least one operating element and the at least one display element are preferably secured on a common printed circuit board, which is in particular preferably secured to the hard plastic support. In this case, preferably all of the operating elements and display elements of the entire functional support are arranged in a single common printed circuit board.

According to a further preferred embodiment, regions that at least partially protrude above the surface are formed from the casting compound on the surface, in particular in the regions of the operating elements. However, in the membrane regions mentioned, the thicknesses specified above of the surface layer remain, in order to ensure sufficient mobility for the tactile feedback of the switches.

The hard plastic support and/or the printed circuit board on which operating elements and/or display elements are arranged may have light guides, light sources and/or light shields.

Such a functional support may be an integral console element or part of a console element for a vehicle, a steering wheel for a vehicle, a medical device, a computer mouse, a games console or an interface for a mobile phone or a desktop phone.

### BRIEF DESCRIPTION OF THE DRAWINGS

Preferred embodiments of the invention are described hereinafter with reference to the drawings, which merely serve for the purpose of explanation and should not be interpreted as restrictive. In the drawings:

FIG. 1 shows a schematic section through a functional support according to the invention, for example along the line A-A of a construction according to FIG. 3;

FIG. 2 shows a representation of the individual process steps of the proposed process;

FIG. 3 shows an example of a panel of an automobile centre console;

FIG. 4 shows the various process steps and process results of a preferred production process, as it is also schematically represented in the steps according to FIG. 5, wherein in a) the open mould is shown with the supplied plastic film, in b) the open mould is shown with the applied plastic film, in c) the open mould is shown with the plastic film applied to the mould contour, and in d) the closed mould is shown, in e) the closed mould is shown with the moulded plastic support and in f) the again closed mould is shown, in g) the open mould is shown just when the blank is being removed and in h) a sectional representation of the blank is given; in i) the open mould is shown with the inserted blank in the course of the second processing step, in j) the closed mould is shown, in k) the closed mould is shown with the flooded front side, and l) shows the corresponding blank, m) shows the blank with the associated cutting points, n) shows the blank with the edge region detached and o) shows the cut-to-size component, and wherein p) shows the not yet cut-to-size component in different perspective representations (top) and sectional representations (bottom), q) shows a further component in such views and r) shows a cut-to-size component but still without inserted functional components; and

FIG. 5 shows a flow diagram of a production process.

### DESCRIPTION OF THE INVENTION

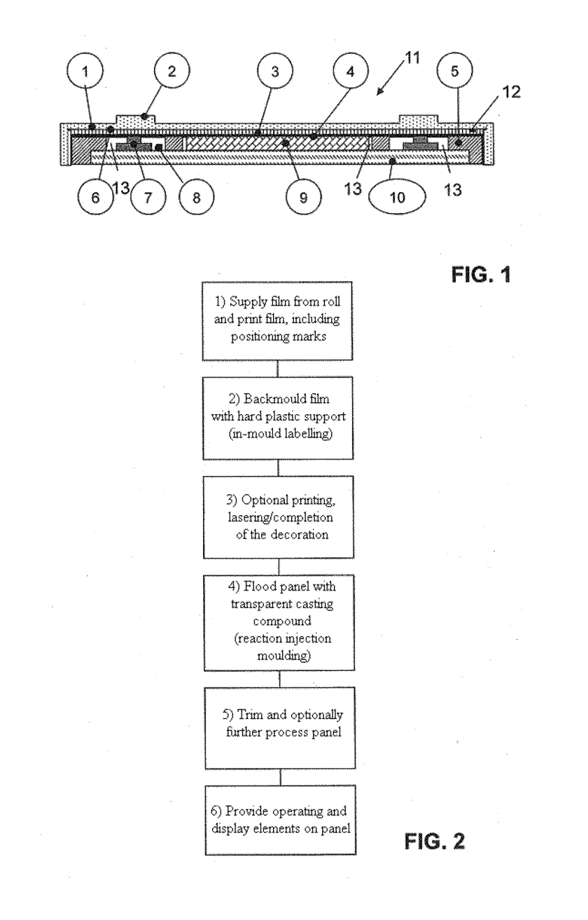

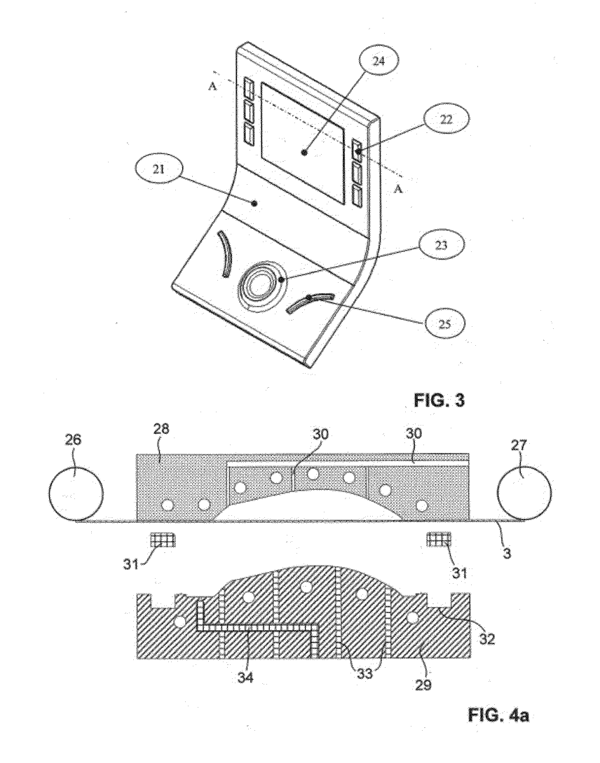

FIG. 3 shows an example of a panel of an automobile centre console, FIG. 1 shows a schematic section through such a functional support according to the invention along the line A-A of a construction according to FIG. 3, and FIG. 2 shows a representation of the individual process steps of the proposed process. Individual steps of this process are now to be explained as follows:

Step 1 from FIG. 2: The soft film 3 (for example TPU 200 μm thick) supplied from a roll is printed and decorated on the front and/or rear side, positioning marks 12 being additionally printed on. On the TPU roll, a positioning mark for each image is printed on respectively to the left and right in a black colour. To the left for the longitudinal alignment a square box, to the right for the lateral alignment an oblong bar. In the sectional representation according to FIG. 1, there is also in the finished component 11 the positioning mark 12, which is at a point where it is for example unproblematic for this mark 12 to be present. However, such positioning aids are often specifically arranged at the edge of the film 3, to be precise in such a way that the positioning mark 12 or the positioning marks 12 is/are then removed in the course of the further processing (step 5 according to FIG. 2) and are no longer included in the finished component.

The film 3 is then positioned by being oriented at the positioning marks 12 in the course of step 2 from FIG. 2. These positioning marks 12 are detected by a respective optical sensor in the injection mould and then the roll is automatically positioned correctly for each individual image by means of advancement and lateral correction. In this way, the film is placed into the injection mould and backmoulded with a hard plastic support 5. The material of this plastic support 5 may be polyamide, polycarbonate or else ABS. In the regions of the operating and display elements, the film 3 is not backmoulded, i.e. clearances 13 remain for these, and the layered construction comprising the film 3 and the surface layer 2 forms there a flexible and elastic skin in the sense of a membrane 6.

The film 3 on the plastic support 5 may then be decorated once again (or for the first time) in the course of step 3 from FIG. 2, for example symbols may be lasered positionally accurately from the printing or other elements may be printed on, for example by the pad printing process. In a next step according to item four from FIG. 2, the plastic support 5 with the film 3 is positioned in a mould and the mould is closed, a gap of at least 0.1 mm remaining between the upper side of the film and the mould. This gap is typically filled under high pressure (low-pressure processes are also possible) with a reactive PU moulding compound, i.e. with clear, i.e. substantially transparent or at least translucent, polyurethane on a PU high-pressure installation. Once the polyurethane has cured (heat input is additionally possible), the panel is preferably also further processed, for example trimmed (peripheral film and sprue, etc.) and possibly also polished. Then, operating elements 7 and display elements 9 may be mounted from behind, this preferably being performed in such a way that a printed circuit board 10 with elements 7 and 9 mounted on it is pushed in from behind and is secured to the structure 5.

Transparent casting compound 1 with formed-on raised button portions 2 or decorative elements: The casting compound for creating the surface layer 1 is the most important material of this invention. It serves on the one hand for generating substantially any desired three-dimensional surface structure (impression of the mould surface). On the other hand, substantially any desired structures, such as forms of button or decorative ridges, etc., may be provided on the surface with the casting compound. This typically takes place within a minimum thickness at the thinnest point of 0.1-2.0 mm. This surface layer 1 may be continuous over the entire surface or else only in sub-regions. The surface layer 1 has the following properties:
elastic, to allow an actuation of the buttons 2/7 in the thin membrane region 6;
firm in the thick button region 2, to provide a hard feel;
transparent within the applied thickness, to make decoration visible;
good adhesion to film;
good abrasion resistance;
high scratch resistance;
no yellowing, even when exposed to strong sunlight;
odour-neutral and emission-free.

The casting compound normally has in the membrane region 6 of the buttons a thickness of 0.1 mm to 0.3 mm, in order to allow the actuation of the button with tactile feedback. In the other regions, the surface feels hard because of the hard plastic backmoulding 5, the hard underlying display elements 9, or the thick button regions 2.

The hardness of the casting compound can be set by the mixing ratio of curing agent to coating composition. It is normally preferred that the hardness lies in the range of 70-100 Shore A, or in the range of 80-100 Shore D, preferably 80-85 Shore D. In particular preferably in the range of 80 Shore A.

This membrane 6 in the button region allows tactile feedback of the buttons 7, and this in the case of a three-dimensional surface 1 which is continuous over the entire component.

Polyurethane has proven to be a highly suitable casting compound material. The polyurethane is applied to the panel by means of high-pressure or low-pressure reaction injection moulding (RIM), an intimate bond between the plastic film 3 and the surface layer 2 automatically forming. There are three possible procedures in this respect:
1. Flooding with casting compound directly after the backmoulding, on the same machine in a second mould; the advantage is that the panel is already properly positioned.
2. As a separate step, placing the panel into an RIM mould, where the gap for the surface coating and the buttons, decorative ridges, etc. are then flooded with polyurethane to form the surface layer 1/2. To allow the mould to be filled, the minimum layer thickness is 200 μm.
3. Same as 2., but after the filling of the mould the layer thickness is also reduced further to 100 μm (0.1 mm) by means of an embossing pressure.

A mould release agent may be advantageous.

After the flooding, the panel is preferably further processed, for example cut to size (film and sprue). It may also be necessary for the transparent casting compound still to be subsequently polished.

Plastic film 3: The film should have the following properties:
deformable and suitable for being backmoulded;
flexible and soft, to ensure the button function (travel);
printable for decoration;
transparent for backlighting and display elements/display regions;
good (durable) adhesion to surface layer;
good (durable) adhesion to hard support structure.

The film 3 preferably consists of a 50-300 μm thick TPU film. The TPU may in this case be aliphatic or non-aliphatic. 200 μm is a preferred thickness.

Similar to the casting compound, the hardness of the film 3 is preferably in the range of 70-100 Shore A, or 80-100 Shore D, preferably 80-85 Shore D. In particular preferably in the range of 80 Shore A.

In order to achieve better adhesion with respect to the backmoulding 5, the film 3 may be cleaned with alcohol, preheated with plasma, corona or flame or include a co-extruded olefin layer.

Alternatively, other materials are also conceivable, such as polyamide PA or a TPE, etc.

Decoration 4: The film 3 may be printed on the front side or on the rear side (for example screen printing). Symbols may already be applied on the film. However, uncontrollable distortion of the symbols and their position may occur during the backmoulding of the soft film 3, so that the following procedure is preferred:
1. printing the film on the front side with symbol colours (for example white);
2. printing the film with surface colour (for example black);
3. backmoulding the printed film;
4. lasering the symbols on the backmoulded component, so ensuring that geometry and position match.

The process can also be used with the film 3 printed on the rear side, but then printing is only performed with surface colour and the symbols are lasered from behind and if necessary also filled with symbol colour by pad printing. Hard plastic support 5: The support 5 must perform the following functions:
1. firm base for film 3, to produce a surface that is as hard and firm as possible in the regions without buttons;
2. good adhesion to the film 3;
3. open windows in the region of the flexible membrane 6;
4. open windows in the region of the display elements/displays 9, unless a transparent material is used or a two-component process with a transparent component;
5. securing possibilities for operating and display components or a printed circuit board 10 with these elements on the rear side;
6. securing possibilities for the integration of the panel in the vehicle/device.

For the backmoulding of the TPU film 3, preferably ABS/PC plastic is used, but PA 6 or ABS/PA or similar systems may also be used.

The wall thickness is substantially dependent on the component size and the installation depth.

Flexible membrane region without plastic backmoulding 6: In order to allow tactile feedback in the case of the operating elements 7 or to actuate a resistive display 9, a membrane 6 is required. This membrane 6 consists only of the decorated film 3 and the casting compound of the surface layer 1. The thickness of the membrane 6 results from the thickness of the film 3 and the thickness of the casting compound of the surface layer 1 in the membrane region. This total thickness should not exceed 600 μm, because otherwise a sharp tactile switching feeling is normally no longer possible.

In this membrane region 6, the film 3 is not backmoulded (window/clearance).

The length of the membrane (distance from edge of the formed-on button 2 to the backmoulding 5) should be in the range of 2-10 mm, preferably in the range of 4-6 mm, typically about 5 mm, but is dependent on the button geometry and the switching feeling to be achieved.

Microswitches/snap domes 7: In order to obtain tactile feedback of the button actuation, a microswitch 7 or a snap dome is provided under the button 2. The actuating force and the snap can be influenced by the choice of the snap dome.

It is one of the very great advantages and unique features of this invention that a tactile button feeling can be produced in a continuous panel surface.

However, resistive buttons (silicone switching mat instead of microswitch) and capacitive buttons can also be achieved, or a combination of these technologies.

Backlighting 8: The backlighting of the buttons or illumination of individual areas or functional lighting may be achieved by means of normal LEDs and/or light guides. However, it is also possible to use a light guiding film or EL films in the case of flat structures.

Display elements/displays 9: Displays may be secured to the plastic support. Thanks to the thin and flexible layer 1/3 over the display 9, it is possible also to use resistive touchscreens as well as capacitive touchscreens.

Printed circuit board 10: The printed circuit board serves as a receptacle for the operating elements 7 and display elements 9. A rigid, flexible or rigid-flexible printed circuit board 10 may be used for this. In the case of extreme surface curvatures, 3D MID technology and the like are also possible.

The printed circuit board 10 may be secured directly to the panel by means of screws, adhesive bonding, or snap-on connections on the plastic backmoulding.

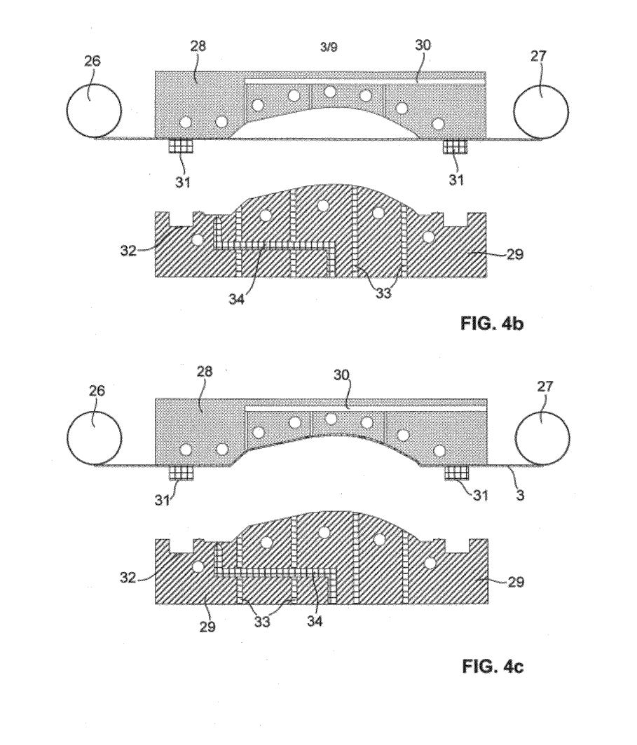

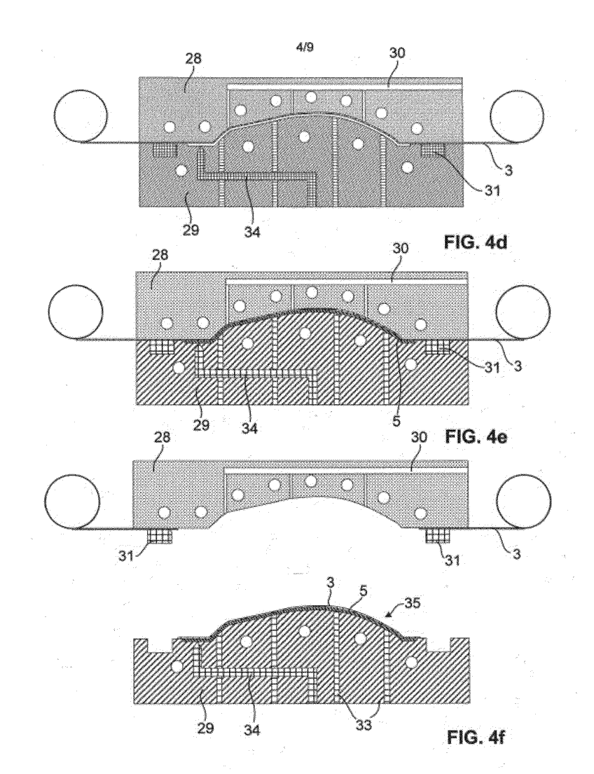

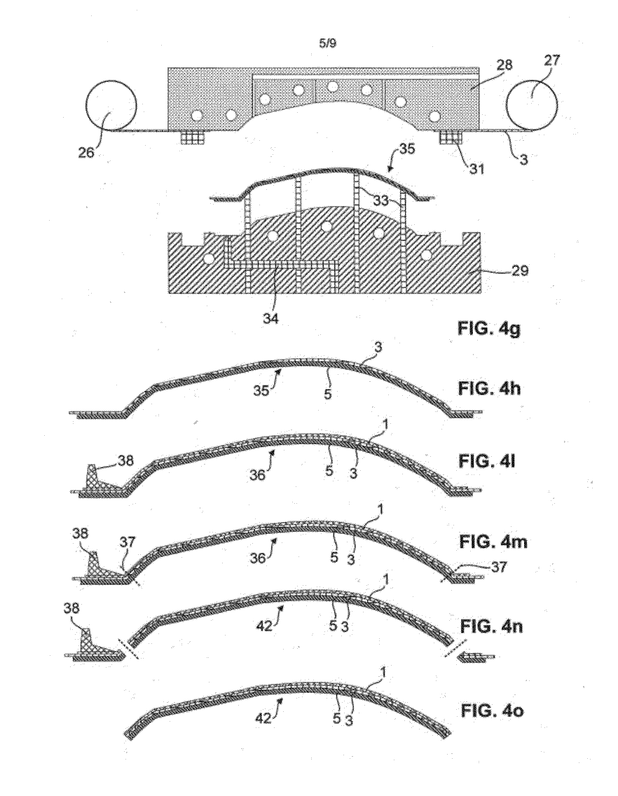

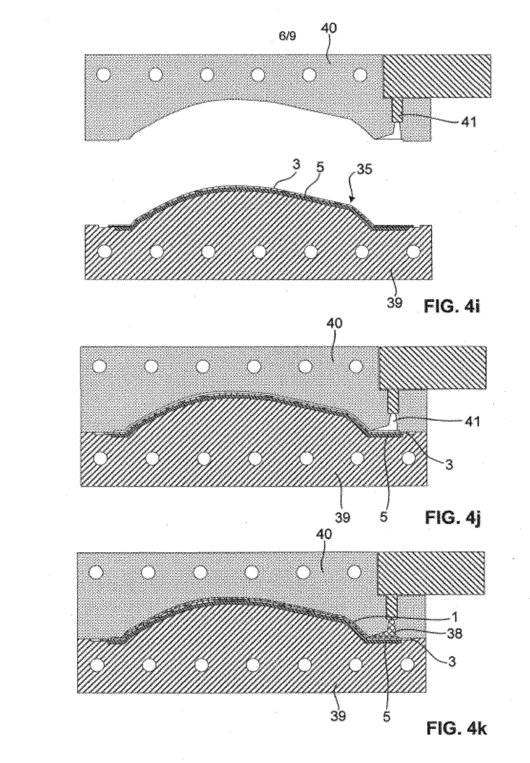

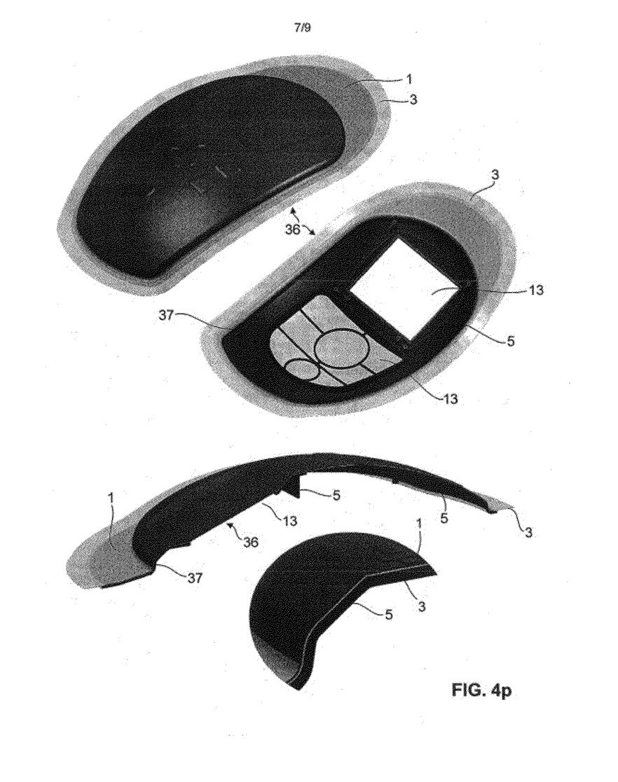

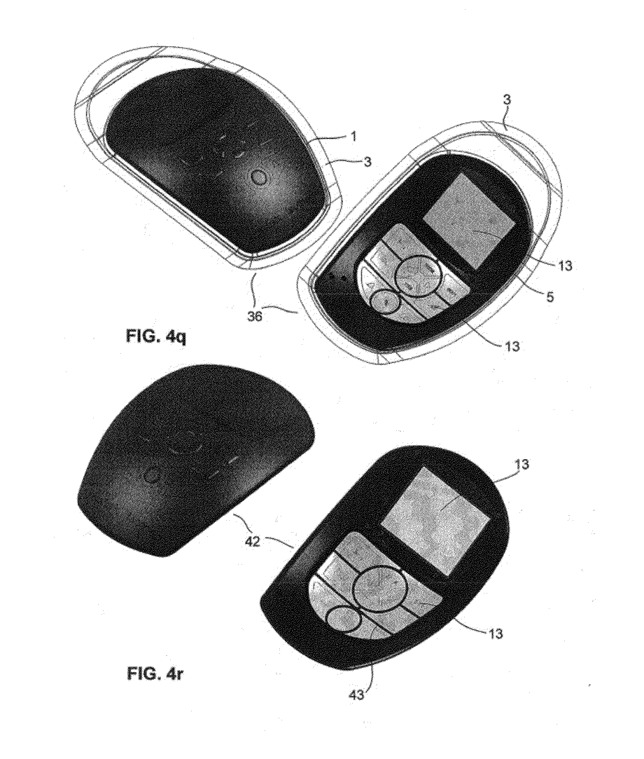

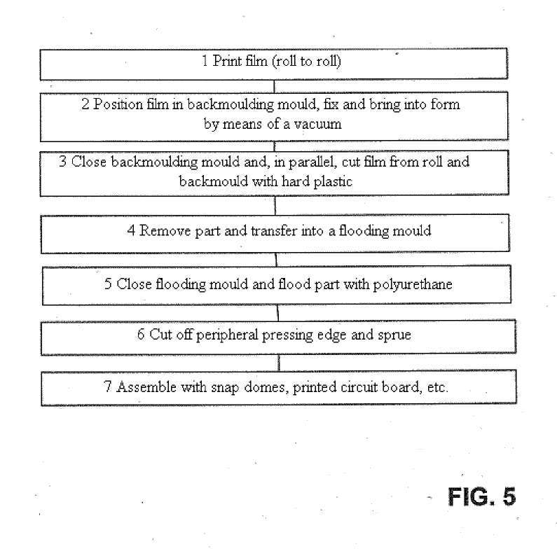

A production process for such a component is presented in detail on the basis of FIGS. 4 and 5. In a first process step, the plastic film 3 is thereby backmoulded with the hard plastic support 5, to be precise in a first injection mould, and, in a subsequent, second production step, the transparent casting compound is moulded on directly on the front side of the plastic film 3 in a second mould.

Specifically, in FIG. 4a the open first injection mould is shown, with an upper injection mould 28, which represents the closing side and which has in particular the concave mould shaping. Provided in the mould are vacuum channels 30, which open out in this concave region. The plastic film 3, which is supplied from a supply roll 26 and is taken up again behind the mould on a winding-up roll 27, is placed over this upper injection mould 28.

Provided underneath is a peripheral clamping frame 31. Provided underneath still further is the lower injection mould 29, which has a convex form corresponding to the concave form in the injection mould 28, and which has in this case the supply line 34 for the hard plastic. Also provided in this mould is a peripheral groove 32 for receiving the clamping frame.

As shown in FIG. 4b, the film is advanced and subsequently pressed against a flat region of the upper injection mould 28 by the clamping frame 31. In the step which then follows, a vacuum is applied via the line 30, and the elastic film 3 is then sucked into the concave region and, as shown in FIG. 4c, in this concave mould lies smoothly against its surface. Subsequently, as shown in FIG. 4d, the mould is then closed. As soon as the mould is closed, the plastic that subsequently forms the hard layer 5 behind the plastic film 3 is supplied via the channel 34. The plastic cures while still in the mould. Subsequently, the mould is opened again; the opened mould is shown in FIG. 4f. Incidentally, it is possible to cut the plastic film 3 into the corresponding peripheral contour right away when closing (FIG. 4d), or to provide a corresponding automatic cutting mechanism for when the mould is opening (cf. FIG. 4f).

Then, according to FIG. 4f, the blank 35 rests on the lower convex mould, and, to allow this blank 35 to be removed cleanly, preferably provided in the lower injection mould 29 are ejection pins 33, which are then pushed upwards, so that the blank 35 can then be readily removed and placed into the second mould. As can be gathered in particular from FIG. 4h, this blank has after the first processing step a two-layered structure, with on the upper side the transparent plastic film 3 and on the lower side the hard plastic structure, which has clearances, as already previously discussed.

This blank 35 is then placed into a second mould, as it is shown in the open state in FIG. 4i. It is placed onto or into the corresponding convex part of the lower mould 36, and the mould is subsequently closed, as is shown in FIG. 4j. Then the casting compound is supplied via a supply channel 31 and is moulded on the side of the film 3 that is facing away from the hard region 5. The result is shown by the closed mould in FIG. 4k. This then resultant blank with a film that is backmoulded and flooded on the other side is shown in FIG. 4i in a sectional representation; this blank 36 is then removed from the second processing mould.

It still has in its edge region widely overhanging regions and, in particular, typically a sprue surplus 38. This is then detached at the intended peripheral cutting points 37, so as to produce, as represented in FIGS. 4m and 4n, a final component 42, which has the desired peripheral contour, and is likewise given in a sectional representation in FIG. 4o.

A possible such component is shown in the upper region of FIG. 4p still as a blank 36, i.e. the overhanging edge regions of film and/or transparent casting compound and/or hard plastic support have not yet been cut off.

A further somewhat different type of construction is shown in FIG. 4q, once again in perspective views from above (on the left) and from below (on the right). Here, the different clearances can be seen very nicely, and the raised portions provided on the surface of the casting compound to form tactile button regions. In FIG. 4r, the finished component, where the edge contour has already been cut off, is shown, and here too the clearances 13 can be seen very nicely, and possibly required ridges 43. In the production process described here, these ridges 43 can be specifically formed in a most particularly intricate and nevertheless well-supporting manner, since they are moulded directly onto the transparent film.

FIG. 5 shows the individual steps once again in an overview. In a first step, the printed film is printed from roll to roll, to be precise either on the upper side or on the underside, or both; it is also additionally possible for certain embossings possibly already to be provided here on the film.

In a second step, the film, as is shown in FIG. 4a, is positioned in the backmoulding mould, fixed and then sucked into, and brought to bear against, the concave regions of the mould.

In the third step, the first mould is closed and, preferably in parallel, the film is cut from the roll, and is backmoulded with the hard plastic material in the mould.

In the following step, the blank is removed and placed into a second mould, a flooding mould. In the then following fifth step, this second mould is closed and flooded on the side opposite from the hard plastic material with the transparent casting compound material, which is also cured in the mould. Subsequently, still in the mould or after removal of the blank from the mould, the peripheral pressing edge is cut and the sprue is thereby likewise cut off right away.

In a final step, the component may be assembled by appropriately adding further functional elements such as snap domes, printed circuit boards, etc. to form the final component.

General advantages of an options component according to the invention:

A three-dimensionally curved panel is provided, with
a continuous surface without gaps
a high-quality, neat appearance,
integrated operating and display elements
buttons with tactile feedback
resistive and capacitive touch displays possible
capacitive elements by printed electronics possible
buttons and decorative elements of almost any desired form
a wide variety of possible surface structures (matt/gloss)
flat structure
reduced components
centre console of cars with integrated buttons and displays
steering wheel with integrated buttons
door panel with integrated buttons
medical devices
computer mouse
games consoles
keypad of any type, for example for mobile phones and desktop phones
handheld devices of all types
covers for household appliances

Correspondingly, the invention relates to a panel comprising a backmoulded film which on the upper side is coated at least in places, preferably all over, with a clear casting compound. Operating and display elements are integrated in this panel. Moreover, the surface layer additionally has formed-on structures. The operating elements are buttons with tactile feedback. The display elements may be resistive or capacitive touch displays. The panel comprises a backmoulded and decorated soft TPU film, which is flooded with polyurethane by the RIM process. Provided on the underside of the buttons are snap domes or contact pills, which produce button haptics and establish electrical contact. The support has a clearance around the periphery of the button geometry, in order to allow the travel of the button when it is depressed. A microswitch or other contact technology may be used on the underside of the buttons. The support may have light guides or light shields, in order to achieve functional lighting. The surface layer may be applied substantially in any desired thickness, form and structure; it may be provided as a continuous surface area or only in individual regions, but then at least in the region of the functional elements and covering them completely without gaps. Typically, the entire surface is provided with a transparent surface layer in the manner of a protective layer, for example to increase scratch resistance. A lens structure may be incorporated in the surface, in order to achieve optical lens effects. The casting compound may in this case also not cure reactively, but by means of heat or other external energy sources.

1. A process for producing a multifunctional functional support with a rigid support structure, in which at least one of operating elements and display elements are arranged behind a transparent surface layer which is continuous over substantially the entire multifunctional support, the process comprising:
i) introducing a flat, flexible plastic film;
ii) placing the plastic film in a positioned manner, into an injection mold, wherein the plastic film is supplied from a roll, and the plastic film is backmolded to form a substantially continuous rigid support structure on a first side, the injection mold being designed in such a way that, in a region of at least one of the operating elements and the display elements, the plastic film is not backmolded, at least in places, and remains exposed in the form of at least one clearance or at least two clearances;
iii) flooding on a second side, facing away from the first side, of the plastic film in the injection mold or, after transferring the plastic film into a further injection mold, in this further injection mold, substantially all over with a transparent curing casting compound in an RIM process, and coating the second side to form a continuous transparent surface layer with a thickness of at least 0.1 mm over substantially the entire functional support, and membrane regions that are flexible at least in places are formed in a region of the clearances;
iv) placing at least one of the operating elements and the display elements into the clearances and joining at least one of the operating elements and the display elements to the rigid support structure.

2. The process according to claim 1, wherein the plastic film is supplied from a roll and, in a first processing step, is backmolded in a first injection mold to form the rigid support structure.

3. The process according to claim 2, wherein, when closing or opening the mold, the plastic film is cut to a peripheral contour.

4. The process according to claim 2, wherein, after the first processing step, the plastic film having the rigid support structure is flooded on a side of the plastic film that is opposite from the rigid support structure with the transparent curing casting compound, and placed into a second mold, and the transparent curing casting compound is molded on the second mold to form the transparent surface layer.

5. The process according to claim 4, wherein the functional support is subsequently completed by adding further functional elements.

6. The process according to claim 1, wherein, before or after step i), the plastic film is printed and/or decorated, on the first and/or the second side.

7. The process according to claim 1, wherein, by step ii), the plastic film is transformed at least in places into a three-dimensional surface form and stabilized in the three-dimensional surface form.

8. The process according to claim 1, wherein the operating element is a switch with tactile feedback and/or wherein the display element is an LCD display, and/or wherein the functional support has both at least one operating element in the form of a switch with tactile feedback and at least one display element.

9. The process according to claim 1, wherein the plastic film is a plastic film of TPU, polyamide, TPE, or any combination thereof.

10. The process according to claim 1, wherein the plastic film has a thickness in a range of 100-300 μm.

11. A process according to claim 1, wherein the casting compound for forming the surface layer is a transparent self-curing resin, a thermosetting polyurethane resin, or any combination thereof, said resin having at least in the region of the operating elements and the membrane regions arranged at least partially around them a thickness of no more than 0.4 mm and/or said resin having in a backmolded region and/or in the membrane region a thickness in the range of 0.1 mm-0.5 mm and the operating elements and decorative elements or display windows being able to have an additional thickness of 0 to 3 mm.

12. The process according to claim 1, wherein, after step ii), the plastic film is printed at least in places and/or is decorated and/or is subjected to laser marking.

13. A multifunctional functional support with at least one operating element and at least one display element, with a plastic film of a thickness in the range of 0.05-0.4 mm, directly backmolded on a first side with a rigid support structure which is continuous apart from at least one or at least two clearances, which film has on the opposite, second side a direct, substantially continuous transparent surface layer of a cured casting compound, there being arranged in at least one of the clearances at least one operating element in the form of a switch with tactile feedback, around which there is a flexible membrane region, around at least part of the periphery, to allow travel of the button, in which region the functional support consists only of plastic film and the surface layer.

14. A functional support produced in a process according to claim 1.

15. The functional support according to claim 13, wherein the at least one operating element and the at least one display element are secured on a common printed circuit board, which is secured to the hard plastic support,
and/or wherein regions that at least partially protrude above the surface layer are formed from the casting compound on the surface layer,
and/or wherein the rigid support structure and/or a printed circuit board on which operating elements and/or display elements are arranged has light guides, light sources and/or light shields,
and/or wherein it is a console element for a vehicle, a steering wheel for a vehicle, a medical device, a computer mouse, a games console or an interface for a mobile phone or a desktop phone.

16. The process according to claim 1, wherein said flat, flexible plastic film is transparent at least in places and has a thickness in a range of 0.05-0.4 mm.

17. The process according to claim 1, wherein at least one positioning mark is printed or embossed onto said flat, flexible plastic film in step i) and in step ii) the flat plastic film is placed in the positioned manner, using the at least one positioning mark, into the injection mold provided with a corresponding positioning means.

18. The process according to claim 1, wherein the plastic film is supplied from a roll, in a form in which it is already printed on a front side and/or a rear side, and, in a first processing step, is backmolded in a first injection mold to form the rigid support structure, wherein, before closing the first injection mold, the plastic film is stretched over convex regions of the mold, covering them, and/or brought to bear against concave regions of the mold by using negative pressure, and subsequently clamped in an edge region, around the periphery, and then the mold is closed.

19. The process according to claim 18, wherein, after the first processing step, the plastic film having the rigid support structure is flooded on a side of the plastic film that is opposite from the rigid support structure with the transparent curing casting compound, the plastic film with the rigid support structure being removed from the first injection mold, with the aid of an ejector, and placed into a second mold, and the curing casting compound is molded on in the second mold to form the transparent surface layer, and the plastic film having the rigid support structure and the transparent surface layer is subsequently cut to a peripheral final component contour to form the functional support.

20. The process according to claim 4, wherein the functional elements are in the form of snap domes, printed circuit boards or lighting elements.

21. The process according to claim 1, wherein, before or after step i), the plastic film is printed and/or decorated, on the first and/or the second side, in a screen printing process, a laser printing process, a stamp printing process, a spray printing process, an offset printing process or a digital printing process.

22. The process according to claim 1, wherein the operating element is a switch with tactile feedback and/or wherein the display element is a touch-sensitive LCD display, and/or wherein the functional support has both at least one operating element in the form of a switch with tactile feedback and at least one display element, in the form of a resistive or capacitive touch-sensitive display element.

23. The process according to claim 1, wherein the plastic film is a plastic film of polyamide 6, polyamide 12, or TPU.

24. The process according to claim 1, wherein the plastic film has a thickness in a range of 150-225 μm.

25. The process according to claim 1, wherein the casting compound for forming the surface layer is at least one of a transparent self-curing resin and a thermosetting polyurethane resin, said resin having at least in the region of the operating elements and the membrane regions arranged at least partially around them a thickness of no more than 0.4 mm, and the surface layer having in these regions a thickness of at least 0.2 mm, and/or said resin having in a backmolded region and/or in the membrane region a thickness in the range of 0.1 mm-0.5 mm and the operating elements and decorative elements or display windows being able to have an additional thickness of 0 to 3 mm.
